(19) United States
(12) Patent Application Publication
(10) Pub. No.: US 2008/0286666 A1
(43) Pub. Date: Nov. 20, 2008

(54) COLOR FILTER AND METHOD OF PRODUCING SAME

(76) Inventor: Hironori KOBAYASHI, Tokyo (JP)

Correspondence Address: LADAS & PARRY LLP, 224 SOUTH MICHIGAN AVENUE, SUITE 1600, CHICAGO, IL, 60604, US

(21) Appl. No.: 12/177,978

(22) Filed: Jul. 23, 2008

Related U.S. Application Data
(62) Division of application No. 11/396,675, filed on Apr. 3, 2006, now abandoned.

(30) Foreign Application Priority Data
Apr. 4, 2005 (JP) 2005-107880

(51) Int. Cl. G02B 1/00

(52) U.S. Cl. 430/7

(57) ABSTRACT

The main object of the present invention is to provide an efficient color filter with no white spots and the like generated in colored layer, and a method of producing the same.

To achiever the object, the invention provides a method of producing a color filter, comprising: a liquid repellent colored layer forming step of forming, on a substrate, a plurality of liquid repellent colored layers having liquid repellency at predetermined intervals; and a light shielding part forming step of coating a light shielding part forming coating solution between the two adjacent the liquid repellent colored layers on the substrate by a discharge method to form a light shielding part.

### BACKGROUND OF THE INVENTION

1. Field of the Invention

The present invention relates to a color filter which can be used in a liquid crystal display apparatus and has a minutely-formed light shielding part, and a method of producing a color filter.

2. Description of the Related Art

Recently; with the development of personal computers, in particular of, portable personal computers, demands for liquid crystal display devices, especially for color liquid crystal display devices tend to increase. Usually, the color liquid crystal display devices are each equipped with a color filter having colored layer in the three primary colors of red (R), green (G) and blue (B) and a light shielding part for partitioning the colors. When electrodes corresponding to each of pixels in R, G and B in the color filter are turned on or off, the liquid each of the pixels in R, G and B to attain color display.

In order to produce such a color filter, for example, a photosensitive resin layer with a light shielding material dispersed is formed over a substrate, and this layer is patterned to yield a light shielding part. Furthermore, such a step is repeated three times, thereby forming colored layer in R, G and B. This method is generally used for the production of the color filter. At the time of the formation of the colored layer, the colored layer is usually formed to cover edges of the light shielding part partially. In this case, however, the film thickness of regions where the colored layer and the light shielding part are laminated becomes large. Consequently, between regions where only the colored layer is formed and the regions where the colored layer and the light shielding part are laminated, a film thickness difference is generated. By this difference, a transparent electrode layer formed on the colored layer may be broken.

Thus, suggested is a method for narrowing the width of regions where the colored layer and the light shielding part overlap (see, for example, Japanese Patent Application Laid-Open No. 11-218607). In this case, the film thickness difference is decreased; however, when the colored layer is formed by photolithography, white spots are generated in the colored layer if the photomask used therefor moves its position over a little. Accordingly, there is a problem that the positioning of the photomask is difficult and the production efficiency of the filter becomes low.

### SUMMARY OF THE INVENTION

Thus, a high quality color filter with no white spots and the like generated in colored layer, and a method of producing the same are desired.

The present invention provides a method of producing a color filter, comprising: a liquid repellent colored layer forming step of forming, on a substrate, a plurality of liquid repellent colored layers having liquid repellency at predetermined intervals; and a light shielding part forming step of coating a light shielding part forming coating solution between the two adjacent liquid repellent colored layers by a discharge method to form a light shielding part.

According to the invention, through the liquid repellent colored layer forming step, the liquid repellent colored layers are formed; therefore, in the light shielding part forming step, the light shielding part forming coating solution does not adhere to the liquid repellent colored layers. Accordingly, the light shielding part can easily be formed with high minuteness between any adjacent two liquid repellent colored layers. At this time, the light shielding part can be formed from the light shielding part forming coating solution without having any gap between the liquid repellent colored layers. Consequently, a high quality color film can be produced with no white spots and the like generated between the liquid repellent colored layers and the light shielding part.

In the invention, there may be a process of forming a wettability-varied pattern having a lowered contact angle to liquid. In the process, the substrate has a photocatalyst-containing layer which contains at least a photocatalyst and a binder, and before the liquid repellent colored layer forming step, a wettability-varied pattern forming step of radiating energy in a pattern form to the photocatalyst-containing layer to form a wettability-varied pattern with a lowered contact angle to liquid is performed. In this case, the liquid repellent colored layers can be formed with high minuteness, using the wettability of the photocatalyst-containing layer. Thus, a high quality color filter can be produced.

In the invention, the liquid repellent colored layer forming step can be a step of forming a plurality of resin colored layers at the predetermined intervals onto the substrate, and radiating plasma to the resin colored layers by use of a fluorine compound as an introducing gas to form the liquid repellent colored layer. In this case, fluorine is introduced into the resin colored layer by the plasma radiation, so that the liquid repellent colored layer can easily be formed. At this time, the use of inorganic material for the substrate does not permit fluorine to be introduced into the substrate. This makes it possible to render regions where the substrate is uncovered between any adjacent two liquid repellent colored layers lyophilic regions, and render regions where the liquid repellent colored layers are formed liquid repellent regions. Thus, there is also produced an advantage that in the light shielding part forming step, this wettability difference is used to make it possible to form the light shielding part easily.

Moreover, in the invention, the liquid repellent colored layer forming step may be a step of using a liquid repellent colored layer forming composition containing a liquid repellent material to form the liquid repellent colored layers. In this case, the liquid repellent colored layer forming composition contains therein the liquid repellent material; therefore, the liquid repellent colored layers having liquid repellency can be easily formed.

Further, the present invention provides a color filter comprising; a substrate, a photocatalyst-containing layer which is formed on the substrate and contains at least a photocatalyst and a binder, a colored layer formed in a pattern form on the photocatalyst-containing layer, and a light shielding part formed to cover an opening part partitioned by the colored layer and edges of the colored layer.

According to the color filter of the invention, the light shielding part is formed to cover edges of the colored layer; therefore, the color filter can be rendered a high quality color filter with no white spots and the like generated at the edges of the colored layer. Additionally, the photocatalyst-containing layer can be rendered a layer having wettabilities varied by irradiation with energy, or the like. Using this wettability difference in the photocatalyst-containing layer or the like, the colored layer can be formed with high minuteness, and a color filter having such colored layer can be produced.

According to the invention, the liquid repellency of the liquid repellent colored layer is used to make it possible to form a light shielding part, with high minuteness, easily between any adjacent two liquid repellent colored layers. Moreover, the light shielding part can be formed without having any gap between the liquid repellent colored layers. Thus, there is produced an advantageous effect that a high quality color filter can be produced with no white spots and the like generated between the liquid repellent colored layers and the light shielding part.

### BRIEF DESCRIPTION OF THE DRAWING

FIGS. 1A and 1B are each a process chart showing an example of a method of producing a color filter of the invention.

FIG. 2 is a schematic sectional view showing an example of the color filter of the invention.

### BEST MODE FOR CARRYING OUT THE INVENTION

The invention relates to a color filter having a light shielding part formed with high minuteness, which can be used in a liquid crystal display device; and a method of producing a color filter. The following will describe them separately.

### A. Method of Producing a Color Filter

First, a method of producing a color filter will be explained.

A method of producing a color filter of the invention comprising: a liquid repellent colored layer forming step of forming, on a substrate, a plurality of liquid repellent colored layers having liquid repellency at predetermined intervals; and a light shielding part forming step of coating a light shielding part forming coating solution between the two adjacent the liquid repellent colored layers on the substrate by a discharge method to form a light shielding part.

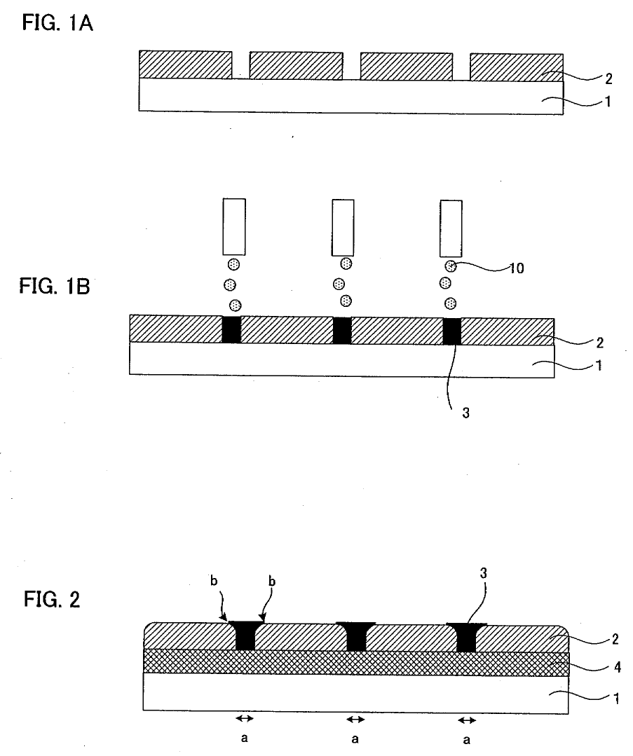

As shown in, for example, FIGS. 1A and 1B, the process of the invention for producing a color filter comprises: a liquid repellent colored layer forming step of forming (FIG. 1A), wherein, on a substrate 1, a plurality of liquid repellent colored layers 2 having liquid repellency are formed at predetermined intervals; and a light shielding part forming step (FIG. 1B), wherein a light shielding part forming coating solution 10 is coated between any of the two adjacent liquid repellent colored layers 2 by a discharge method to form a light shielding part 3.

According to the invention, through the liquid repellent colored layer forming step, the liquid repellent colored layers are formed; therefore, when the light shielding part forming coating solution is coated between the liquid repellent colored layers in the light shielding part forming step, the light shielding part forming coating solution does not adhere onto the liquid repellent colored layers. Accordingly, the light shielding part can easily be formed with high minuteness only between any of the two adjacent liquid repellent colored layers.

Moreover, in the invention, by adjusting or the like the coating amount of the light shielding part forming coating solution is adjusted, the light shielding part can be formed without having any gap between any adjacent two liquid repellent colored layers. Consequently, a high quality color film can be produced with no white spots and the like generated between the light shielding part and the liquid repellent colored layers.

Hereinafter, each of the steps in the method of producing the color filter of the invention will be described in detail.

### 1. Liquid Repellent Colored Layer Forming Step

First, the liquid repellent colored layer forming step in the invention is described here. The step is a step of forming, on a substrate, a plurality of liquid repellent colored layers having liquid repellency at predetermined intervals. The liquid repellent colored layers are usually formed of three colors of red (R), green (U) and blue (B). The layers may be formed of four or more colors. The predetermined intervals means intervals each having a width which is equal to or smaller than the (line) width of a light shielding part to be formed in the light shielding part forming step which will be detailed later. The width of the intervals is appropriately selected in accordance with the kind of the color filter to be produced or the like. Usually, the width is preferably from about 0.1 to 100 μm, more preferably from about 5 to 30 μm.

About the liquid repellency of the liquid repellent colored layers, preferably, the contact angle thereof with liquid having a surface tension of 40 mN/m is 10° or more; more preferably, the contact angle thereof with liquid having a surface tension of 30 mN/m is 10° or more; and even more preferably, the contact angle thereof with liquid having a surface tension of 20 mN/m is 10° or more. This is because, when the contact angle with the liquids is small, the liquid repellency is insufficient and thus in the light shielding part forming step, to detailed later, a light shielding part forming coating solution unfavorably adheres onto the liquid repellent colored layers; accordingly, a light shielding part may not be formed with high minuteness at ease.

The contact angle with liquids here is obtained from the results or a graph of the results of measuring (30 seconds after of dropping liquid droplets from a micro syringe) the contact angle with liquids having various surface tensions using a contact angle measuring device (CA-Z type manufactured by Kyowa Interface Science, Co., Ltd). Moreover, at the time of the measurement, as the liquids having the various surface tensions, wetting index standard solution manufactured by JUNSEI CHEMICAL CO., LTD. were used.

In the present step, the method for forming the liquid repellent colored layer is not particularly limited. The method may be, for example, a method of using a material having liquid repellency to form the liquid repellent colored layers, or a method of forming resin colored layer having no liquid repellency and then applying treatment for giving liquid repellency to the resin colored layer.

In the invention, it is particularly preferred to adopt a method of forming a plurality of resin colored layers at predetermined intervals on a substrate, and radiating plasma to the resin colored layers by use of a fluorine compound, thereby forming the liquid repellent colored layers (hereinafter referred to as a first embodiment), or a step of using a liquid repellent colored layer forming composition having a liquid repellent material to form liquid repellent colored layers (hereinafter referred to as a second embodiment). According to this method, the above-mentioned liquid repellent colored layers can be formed at ease. Each of the embodiments will be described hereinafter.

### a. FIRST EMBODIMENT

First, the first embodiment of the liquid repellent colored layer forming step is described. The method for forming the liquid repellent colored layer in the first embodiment is a method of forming a plurality of resin colored layers at predetermined intervals on a substrate, and radiating plasma to the resin colored layers by use of a fluorine compound as an introducing gas, thereby forming the liquid repellent colored layers.

When plasma is radiated by use of a fluorine compound as an introducing gas, fluorine can be introduced into organic material. Accordingly, by applying the plasma radiation to the above-mentioned resin colored layers, fluorine can be introduced into the resin colored layers so that the resin colored layers can be rendered liquid repellent colored layers having liquid repellency. When a substrate made of inorganic material is used as the above-mentioned substrate at this time, fluorine is not introduced into the substrate. This makes it possible to render regions where the liquid repellent colored layers are formed liquid repellent regions, and render regions where the substrate is uncovered between any adjacent two liquid repellent colored layers lyophilic regions. In the light shielding part forming step, to be detailed later, by using this wettability difference, a light shielding part can be formed with high minuteness.

The above-mentioned resin colored layers do not need to have liquid repellency, and may be the same as a colored layer in any ordinary color filter. The method for forming the resin colored layers may also be the same as for forming a colored layer in any ordinary color filter. For example, a pigment dispersing method, a printing method or the like may be used. Moreover, for example, when the substrate has a photocatalyst-containing layer which contains a photocatalyst and a binder, and, before the liquid repellent colored layer forming step, a wettability-varied pattern forming step of forming, in the photocatalyst-containing layer, a wettability-varied pattern having a lowered contact angle to liquid is performed as will be detailed later, the resin colored layers may be formed by use of the wettability-varied pattern. Description of such a wettability-varied pattern forming step is not repeated here since the step will be described in detail later.

The arrangement of the resin colored layers formed by the present embodiment may be a known arrangement of a stripe, mosaic, triangle, four-pixel-arranged type, or any other type. The area of a region where the arrangement is formed is appropriately selected in accordance with the kind and the like of the color filter to be produced.

The material used to form the resin colored layers is appropriately selected in accordance with the method for forming the resin colored layers, and the detailed description thereof is not repeated here since the material is the same as used to form colored layer in any ordinary color filter.

The substrate used in the present embodiment can be the same as those conventionally used for a color filter. Specifically, a transparent rigid material without flexibility, such as a quartz glass, a pyrex (registered trademark) glass, and a synthetic quartz plate, and a transparent flexible material having flexibility, such as a transparent resin film and an optical resin plate, or the like can be presented. In the present embodiment, it is preferred to use a substrate made of any one of the inorganic materials out of the above-mentioned materials. As described above, the use of the inorganic material substrate as the above-mentioned substrate does not permit fluorine to be introduced into the substrate even if plasma radiation using a fluorine compound as an introducing gas is performed. Thus, regions where the substrate is uncovered can be used as lyophilic regions.

As described above, the substrate may have a photocatalyst-containing layer which contains a photocatalyst and a binder.

The method for radiating plasma to the resin colored layers, using a fluorine compound as an introducing gas, is not particularly limited if the method is a method capable of introducing fluorine into the resin colored layers. The method may be, for example, a method of radiating plasma in a vacuum, or a method of radiating plasma in the atmospheric pressure. The plasma may be radiated only to the resin colored layers, or may be radiated to the resin colored layers and the uncovered substrate.

As the fluorine compound of the introducing gas used to radiate the plasma, for example, a carbon fluoride (CF₄), a fluorine nitride (NF₃), a sulfur fluoride (SF₆), C₂Cl₃F₃, C₂F₆, C₃F₆ or the like can be presented. Conditions for radiating the plasma may be appropriately selected in accordance with an apparatus for the radiation or the like.

In the present embodiment, it is preferable to carry out the plasma irradiation under an atmospheric pressure. Thereby, since a pressure reduction apparatus, or the like, is not needed, it is preferable in terms of the cost, the production efficiency, or the like. The atmospheric pressure plasma irradiation conditions are as follows. For example, the power source output may be same as that used for a common atmospheric pressure plasma irradiation apparatus. Moreover, at the time, the distance between the plasma irradiation electrode and the above-mentioned light shielding part is about 0.2 to 20 mm, it is particularly preferably about 1 to 5 mm. Furthermore, the flow rate of a fluorine compound used as the above-mentioned introducing gas is about 1 to 100 L/min, and it is particularly preferably about 5 to 50 L/min. The substrate conveyance rate at the time is about 0.1 to 10 m/min, and it is particularly preferably about 0.5 to 5 m/min.

In the present embodiment, the presence of the fluorine in the resin colored layers can be confirmed by measuring the ratio of the fluorine element in the all elements detected form the surface of the resin colored layers by the analysis with an X ray photoelectron spectrometer (XPS: ESCALAB 220i-XL). Moreover, the above-mentioned ratio of the fluorine at the time is preferably 10% or more.

### b. SECOND EMBODIMENT

Next, the second embodiment of the liquid repellent colored layer forming step is described. In the second embodiment, the method for forming the liquid repellent colored layer is a method of using a liquid repellent colored layer forming composition containing a liquid repellent material to form the liquid repellent colored layers. According to the present embodiment, the liquid repellent colored layer forming composition, which contains a liquid repellent material, is used to form the liquid repellent colored layers; therefore, the formed liquid repellent colored layers can have liquid repellency.

The liquid repellent colored layer forming composition is not particularly limited if the composition contains a liquid repellent material and is further capable of forming the liquid repellent colored layers. The composition may be, for example, a composition wherein a liquid repellent material is added to a colored layer forming composition used to form a colored layer in any ordinary color filter.

The liquid repellent material is not particularly limited if the material exhibits liquid repellency when the material is made into the liquid repellent colored layers. The material may be, for example, a material with or without polymerizability. An example of the liquid repellent material is a surfactant having liquid repellency. As such surfactant, specifically, hydrocarbons of the respective series of NIKKO L BL, BC, BO, and BB manufactured by Nikko Chemicals Co., Ltd.; fluorine base or silicone base nonionic surfactants such as ZONYL FSN and FSO manufacture by Du Pont Kabushiki Kaisha, Surflon S-141 and 145 manufactured by ASAHI GLASS CO., LTD., Megaface F-141 and 144 manufactured by DAINIPPON INK AND CHEMICALS, Inc., FTERGENT F-200 and F251 manufactured by NEOS, UNIDYNE DS-401 and 402 manufactured by DAIKIN INDUSTRIES, Ltd., and Fluorad FC-170 and 176 manufactured by 3M can be cited; and cationic surfactants, anionic surfactants and amphoteric surfactants also can be used.

The liquid repellent material is contained in the liquid repellent colored layer forming composition in an amount ranging preferably from about 0.001 to 10% by weight, more preferably from about 0.1 to 3% by weight. When the liquid repellent material is contained in an amount within such a range, the liquid repellent colored layers formed can have liquid repellency as described above.

The method for forming the liquid repellent colored layer by use of the liquid repellent colored layer forming composition may be the same for forming the resin colored layer in the first embodiment, and is, for example, a pigment dispersing method or a printing method. In the case of performing the wettability-varied pattern forming step, which is a step of forming a wettability-varied pattern having a lowered contact angle to liquid in the photocatalyst-containing layer, before the liquid repellent colored layer forming step, the liquid repellent colored layers may be formed by use of the wettability-varied pattern. The wettability-varied pattern forming step will be described in detail later. Thus, the description thereof is not repeated here. The substrate used in the present embodiment is the same as used in the first embodiment. Thus, the detailed description thereof is also not repeated. In the embodiment, the substrate is preferably a substrate having lyophilicity, and the substrate may be a substrate to which treatment for giving lyophilicity is applied. This makes it possible to render regions where the substrate is uncovered between any adjacent two liquid repellent colored layers lyophilic regions so as to form a light shielding part with higher minuteness in the light shielding part forming step, to be detailed below.

### 2. Light Shielding Part Forming Step

Next, the light shielding part forming step in the invention is described. The step is a step of coating a light shielding part forming coating solution between adjacent two liquid repellent colored layers on the substrate by a discharge method, thereby forming a light shielding part.

The discharge method for coating the light shielding part forming coating solution is not particularly limited if the method is capable of coating the light shielding part forming coating solution between the liquid repellent colored layer s. Examples thereof include an ink-jetting method and a method using a dispenser. In the invention, the ink-jetting method is preferred since the method makes it possible to form the light shielding part with particularly high minuteness. The apparatus used in the ink-jetting method is not particularly limited. Thus, there can be used ink-jetting apparatuses using various methods such as a method of continuously jetting the light shielding part forming coating solution which is electrostatically charged and controlling the jet by a magnetic field, a method of using a piezoelectric element to intermittently jet the light shielding part forming coating solution, and a method of heating the light shielding part forming coating solution and using foams generated therefrom to intermittently jet the solution.

The light shielding part forming coating solution is roughly classified into water based solution and oil based solution. In the invention, any one of the two light shielding part forming coating solutions may be used. Preferably, the water based light shielding part forming coating solution is used from the viewpoint of the surface tension thereof.

In the water based light shielding part forming coating solution used in the invention, as the solvent therein, water alone or a mixed solvent of water and a water-soluble organic solvent can be used. In the oil based light shielding part forming coating solution, a solvent made mainly of a high boiling point solvent is preferably used in order to prevent the head to be used from being blocked and the like. Examples of the light shielding material used in the light shielding part coating solution include carbon fine particles, metal oxide, inorganic pigment, and organic pigment. In order to improve the dispersibility or fixability thereof, a soluble or insoluble resin may be incorporated into the solvent. Besides, the following may be added thereto if necessary: a surfactant such as a nonionic surfactant, a cationic surfactant or an amphoteric surfactant; a preservative; an antifungal agent; a pH adjustor; an antifoaming agent; an ultraviolet absorber; a viscosity adjustor; and a surface tension adjustor.

Since the light shielding part forming coating solution used in any ordinary ink-jetting method has a low suitable-viscosity, the solution cannot contain a large amount of a binder; however, the light shielding material in the light shielding part forming coating solution is made into particles encapsulated with a resin, whereby the light shielding material itself can be caused to have fixability. Such a light shielding part forming coating solution can also be used in the invention. Furthermore, what is called hot melt ink or UV curable ink can also be used.

In the invention, it is particularly preferred to use a UV curable light shielding part forming coating solution. The use of the UV light shielding part forming coating solution makes it possible to rapidly curing the solution by radiating UV onto the solution, after the solution is discharged by the discharge method. Thus, the resultant can be immediately forwarded to the next step. Accordingly, a color filter can be effectively produced. The material used in the UV curable light shielding part forming coating solution is, for example, a substance made mainly of a prepolymer, a monomer, a photopolymerization initiator, and the light shielding material. As the prepolymer, any one of the following prepolymers can be used without any especial limitation: a polyester acrylate, a polyurethane acrylate, an epoxy acrylate, a polyether acrylate, an oligo-acrylate, an alkyd acrylate, a polyol acrylate, a silicone acrylate, and others.

As the monomer, the following can be used: a vinyl monomer such as a styrene or a vinyl acetate; a monofunctional acrylic monomer such as an n-hexyl acrylate, or a phenoxyethyl acrylate; or a polyfunctional acrylic monomer such as a diethylene glycol diacrylate, a 1,6-hexanediol diacrylate, a hydroxypiperinic acid ester neopentyl glycol diacrylate, a trimethylolpropane triacrylate, or a dipentaerythritol hexaacrylate.

The prepolymers and the monomers may be used alone or in combination of two or more thereof.

As the photopolymerization initiator, a photopolymerization initiator that is selected from the following and can give a desired wettability for curing and recording can be used: an isobutyl benzoin ether, an isopropyl benzoin ether, a benzoin ethyl ether, a benzoin methyl ether, a 1-phenyl-1,2-propanedione-2-oxime, a 2,2-dimethoxy-2-phenylacetophenone, a benzil, a hydroxycyclohexyl phenyl ketone, a diethoxyacetophenone, a 2-hydroxy-2-methyl-1-phenylpropane-1-one, a benzophenone, a chlorothioxanthone, a 2-chlorothioxanthone, an isopropylthioxanthone, a 2-methylthioxanthone, a chlorine-substituted benzophenone, a halogen-substituted alkyl allyl ketone, and others. If necessary, a photopolymerization-initiating auxiliary, such as an aliphatic amine or an aromatic amine, or a photo-sensitizer such as thioxanthone may be added.

In the present step, it is preferred to form the light shielding part with the adjustment of the coating amount of the light shielding part forming coating solution so as not to generate any gap between the formed light shielding part and the liquid repellent colored layer. This makes it possible to produce a high quality color filter wherein no white spots are generated between the liquid repellent colored layers and the light shielding part.

The film thickness of the light shielding part formed in the present step is preferably from about 0.1 to 5 μm, more preferably from about 1 to 2 μm.

### 3. Others

If necessary, the method of producing the color filter of the invention may comprise, for example, a transparent electrode layer forming step of forming a transparent electrode layer, an alignment layer forming step of forming an alignment layer, or any other appropriate step besides the liquid repellent colored layer forming step and the light shielding part forming step. Each of such steps can be made the same those as in ordinary color filter producing processes. Thus, the detailed description here is not repeated.

As described above, in the invention the wettability-varied pattern forming step may be performed before the liquid repellent colored layer forming step. Hereinafter, the wettability-varied pattern forming step will be described.

### (Wettability-Varied Pattern Forming Step)

The wettability-varied pattern forming step in the invention is a step performed before the liquid repellent colored layer forming step when the substrate has a photocatalyst-containing layer, which contains a photocatalyst and a binder; and is a step of radiating energy in a pattern form to the photocatalyst-containing layer, thereby forming a wettability-varied pattern having a lowered contact angle to liquid.

In the present step, by forming the wettability-varied pattern, which has a lowered contact angle to liquid, the liquid repellent colored layers can be formed with high minuteness in the liquid repellent colored layer forming step, using the wettability of this wettability-varied pattern. Consequently, a high quality color filter can be produced.

About the contact angle of the photocatalyst-containing layer to liquid before the radiation of the energy, preferably, the contact angle thereof with liquid having a surface tension of 40 mN/m is 10° or more; more preferably, the contact angle thereof with liquid having a surface tension of 30 mN/m is 10° or more; and even more preferably, the contact angle thereof with liquid having a surface tension of 20 mN/m is 10° or more. This is because regions in the photocatalyst-containing layer where no energy is radiated are used as liquid repellent regions; therefore, if the contact angle thereof with the liquids is small, the liquid repellency is insufficient so that the liquid repellent colored layer may not be easily formed using a difference between the varied wettability of the wettability-varied pattern and the original wettability of the photocatalyst-containing layer in the liquid repellent colored layer forming step.

In connection with the wettability of the wettability-varied pattern obtained by radiating energy to the photocatalyst-containing layer, specifically, the energy is radiated in such a manner that preferably the contact angle thereof with liquid having a surface tension of 40 mN/m is less than 9°; preferably the contact angle with liquid having a surface tension of 50 mN/m is 10° or less; and more preferably the contact angle with liquid having a surface tension of 60 mN/m is 10° or less. This is because, if the contact angle with the liquids is large, the lyophilicity is insufficient, and thus, in some cases, in the liquid repellent colored layer forming step, the liquid repellent colored layer are formed over the wettability-varied pattern formed in the present step to repel the resin colored layer forming coating solution for forming the resin colored layer, or the liquid repellent colored layer forming coating solution; thus, the liquid repellent colored layer are not easily formed with high minuteness. The contact angles to the liquids can be measured by the above-mentioned method.

The shape of the wettability-varied pattern formed in the step is appropriately selected in accordance with the pattern of the liquid repellent colored layer. Hereinafter, the photocatalyst-containing layer used in this wettability-varied pattern forming step, and the method for radiating the energy will be described.

a. Photocatalyst-Containing Layer

The photocatalyst-containing layer used in the step is not particularly limited as long as the layer contains a photocatalyst and a binder and is formed over a surface of the above-mentioned substrate.

As the photocatalyst contained in the photocatalyst-containing layer, those known as semiconductors, such as a titanium dioxide (TiO₂), a zinc oxide (ZnO), a tin oxide (SnO₂), a strontium titanate (SrTiO₃), a tungsten oxide (WO₃), a bismuth oxide (Bi₂O₃), and an iron oxide (Fe₂O₃) can be presented. Besides the semiconductors, a metal complex, silver or the like can be used. In the invention, one or two or more kinds as a mixture can be selected and used from them.

In the present invention, in particular, a titanium dioxide can be used preferably since it has high band gap energy, chemically stable without the toxicity, and easily obtainable. There are an anatase type and a rutile type in the titanium dioxides, and either can be used in the present invention, however, the anatase type titanium dioxide is preferable. The anatase type titanium dioxide has a 380 nm or less excitation wavelength.

As the anatase type titanium dioxide, for example, a hydrochloric acid deflocculation type anatase type titania sol (STS-02 (average particle diameter 7 nm) manufactured by ISHIHARA SANGYO KAISHA, LTD., ST-K01 manufactured by ISHIHARA SANGYO KAISHA, LTD.), a nitric acid deflocculation type anatase type titania sol (TA-15 (average particle diameter 12 nm) manufactured by Nissan Chemical Industries, Ltd.), or the like can be presented.

With a smaller particle diameter of the photocatalyst, the photocatalyst reaction can be generated effectively, and thus it is preferable. An average particle diameter of 50 nm or less is preferable, and use of a photocatalyst of 20 nm or less is particularly preferable.

The binder is not particularly limited as long as it can lower the contact angle of photocatalyst containing layer surface a liquid by the function of the photocatalyst accompanied by the energy irradiation. In particular, those having a high bond energy such that the principal skeleton is not decomposed by the photo excitation of the photocatalyst, and having an organic substituent to be decomposed by the function of the photocatalyst are preferable. Specifically, (1) an organopolysiloxane to provide high strength by hydrolysis or polycondensation of a chloro or alkoxy silane, or the like by the sol gel reaction or the like, (2) an organopolysiloxane obtained by cross-linking a reactive silicone having the excellent water repellent property or the oil repellent property, or the like can be presented. As for the material used in the photocatalyst-containing layer represented by the organopolysiloxane or the like, those disclosed in the JP-A No. 2001-272774 and others can be used.

The method for forming the photocatalyst-containing layer may be a method of dispersing the photocatalyst and the binder together with optional other additives as needed into a solvent to prepare a coating solution, and coating this coating solution to the substrate or the like. The used solvent is preferably an alcoholic organic solvent such as an ethanol or an isopropanol. The coating can be performed by a known coating method such as spin coating, spray coating, dip coating, roll coating, or bead coating. When the coating solution contains an ultraviolet curable component as the binder, ultraviolet rays are radiated onto the solution so as to cure the coated layer, whereby the photocatalyst-containing layer can be formed.

When this photocatalyst-containing layer, which contains the binder, is subjected to the plasma radiation in the first embodiment of the liquid repellent colored layer forming step, the layer is usually made lyophilic. This is because the plasma radiation causes removal of organic groups expressing the liquid repellency in the above-mentioned organopolysiloxane so that Si—OH bonds make their appearance in the surface.

b. Energy Radiating Method

Next, the energy radiating method in the present step is described. The energy radiating method is not particularly limited as long as the method is a method capable of lowering the contact angle of the photocatalyst-containing layer to liquid into a pattern form so as to form the wettability-varied pattern.

The energy radiated at this time may be any energy ray capable of exciting the photocatalyst to vary the wettability of the photocatalyst-containing layer, and is not limited to visible rays.

For the energy radiation, in general, the light wavelength can be set in a range of 400 nm or less, preferably in a range of 150 to 380 nm because the preferable photocatalyst used for the photocatalyst-containing layer is a titanium dioxide, and a light having the above-mentioned wavelength is preferable as the energy for activating the photocatalyst function by the titanium dioxide.

Examples of a light source that can be used for the energy radiation include various light sources such as a mercury lamp, a metal halide lamp, a xenon lamp, and an excimer lamp. A method of using a laser such as an excimer or YAG laser and radiating the laser so as to draw a pattern may be used besides a method of using a light source as described above to radiate light therefrom in a pattern form through a photomask.

The quantity of the energy radiated at the time of the energy radiation is a radiation quantity necessary for varying the wettability of the photocatalyst-containing layer. At this time, the energy radiation is performed while the photocatalyst-containing layer is heated, whereby the oxidization-decomposability thereof can be raised so that the wettability can be effectively varied. Thus, such a method is preferred. Specifically, the layer is heated preferably at a temperature ranging from 30 to 80° C.

The direction along which the energy is radiated is not particularly limited, and thus the light may be radiated from the side where the photocatalyst-containing layer is formed, or from the side where the photocatalyst-containing layer is not formed.

c. Others

In the case of forming the liquid repellent colored layer according to the second embodiment of the liquid repellent colored layer forming step using the wettability-varied pattern, an energy radiating step of radiating energy onto the photocatalyst-containing layer may be performed after the liquid repellent colored layer forming step. This makes it possible to render regions where the photocatalyst-containing layer is uncovered lyophilic regions and use the liquid repellency of the liquid repellent colored layer and the lyophilicity of the photocatalyst-containing layer to form the light shielding part with high minuteness between the liquid repellent colored layers. The energy radiation may be performed by radiating the energy onto the whole surface.

### B. Color Filter

Next, the color filter of the invention is described. The color filter of the invention is a color filter comprising; a substrate, a photocatalyst-containing layer which is formed on the substrate and contains at least a photocatalyst and a binder, a colored layer formed in a pattern form on the photocatalyst-containing layer, and a light shielding part formed to cover an opening part partitioned by the colored layer and edges of the colored layer.

As shown in, for example, FIG. 2, the color filter of the invention may be a color filter containing a substrate 1, a photocatalyst-containing layer 4 which is formed on the substrate 1, a colored layer 2 formed in a pattern form on the photocatalyst-containing layer 4, and a light shielding part 3 formed to cover opening parts (regions represented by “a”) partitioned by the colored layer 2 and edges (regions represented by “b”) of the colored layer 2.

According to the invention, the light shielding part is formed to cover the edges of the colored layer; therefore, white spots are not generated near the edges of the colored layer. Since the photocatalyst-containing layer contains a photocatalyst and a binder, the layer can be rendered a layer having a wettability variable according to the function of the photocatalyst accompanied by energy radiation or the like. Accordingly, the colored layer can be formed with high minuteness, using a difference between the varied wettability and the original wettability. As a result, a color filter having such colored layer can be produced.

Hereinafter, each of the constituents of the invention will be described in detail.

### 1. Light Shielding Part

The light shielding part used in the color filter of the invention is not particularly limited as long as the part is a light shielding part formed to cover opening part partitioned by the colored layer and edges of the colored layer.

In the invention, the light shielding part is a part which covers the edges of the colored layer, to be detailed later, preferably by about 0.1 to 20 μm, more preferably by about 1 to 5 μm. This makes it possible to prevent the generation of white spots at the edges of the colored layer. In the invention, the edges of the colored layer mean regions near boundaries between the colored layer and the photocatalyst-containing layer, specifically, regions which extend from boundaries between the colored layer and the photocatalyst-containing layer toward inner portions of the colored layer over a width of about 0.1 to 20 μm, in particular, about 1 to 5 μm.

The (line) width of the light shielding part is preferably from about 5 to 240 μm; more preferably from about 5 to 30 μm; even more preferably from about 10 to 20 μm. The film thickness of the light shielding part is preferably from about 0.1 to 50 μm, more preferably from about 0.5 to 10 μm. This makes it possible to make the light shielding property of the light shielding part high and produce a high quality color filter having a wide display area. The (pattern) shape of the light shielding part is appropriately selected in accordance with the kind of the color filter to be produced, the shape of the colored layer, and so on.

In the invention, the method for forming the light shielding part is not particularly limited, and may be, for example, a photolithographic method or a printing method. In the invention, it is preferred that the colored layer, to be detailed later, has liquid repellency and the liquid repellency is used to form the light shielding part by an ink-jetting method. This makes it possible to form the light shielding part with high minuteness over the opening parts partitioned by the colored layer and produce a high quality color filter.

The method for forming the light shielding part by the ink-jetting method may be the same as described about the light shielding part forming step in the above-mentioned item “A. Method of producing a color filter”. Thus, the detailed description thereof is not repeated here.

### 2. Colored Layer

Next, the colored layer used in the invention is described. The colored layer is not particularly limited as long as the layer is a layer formed in a pattern form on the photocatalyst-containing layer. In the invention, the colored layer preferably has liquid repellency. This makes it possible to use the liquid repellency of the colored layer to form the light shielding part with high minuteness so as to cover the opening part portioned by the colored layer.

When the colored layer has liquid repellency in the invention, it is preferred that fluorine is contained in the whole or the surface of the colored layer. This makes it possible to make the liquid repellency of the colored layer high. The surface of the colored layer referred to here is a region extending inwards from the topmost surface of the colored layer by about 50 nm. The presence of the fluorine in the colored layer can be confirmed by measuring the ratio of the fluorine element in the all elements detected form the colored layer by the analysis with an X ray photoelectron spectrometer (XPS: ESCALAB 220i-XL). Moreover, the ratio of the fluorine at the time is preferably 10% or more.

About the liquid repellency of the colored layer, preferably, the contact angle thereof with liquid having a surface tension of 40 mN/m is 10° or more; more preferably, the contact angle thereof with liquid having a surface tension of 30 mN/m is 10° or more; and even more preferably, the contact angle thereof with liquid having a surface tension of 20 mN/m is 10° or more. This is because if the contact angle with the liquids is small, the liquid repellency is insufficient and thus when the above-mentioned light shielding part is formed, a light shielding part forming coating solution adheres onto the colored layer; accordingly, a light shielding part may not be formed with high minuteness at ease. The contact angle with the liquids is measured by the method mentioned above.

In the invention, the method for forming the colored layer is not particularly limited, and is preferably an ink-jetting method using a difference in wettability inside the photocatalyst-containing layer, which will be detailed later. This makes it possible to form the colored layer with high minuteness without undergoing any complicated step. Thus, the method is also preferred from the viewpoint of production efficiency and so on. The method for forming the colored layer may be the same as described about the liquid repellent colored layer forming step in the above-mentioned item “A. Method of producing a color filter”. Thus, the detailed description thereof is not repeated here.

Further, the colored layer is usually formed of three colors of red (R), green (G) and blue (B). The layer may be formed of four or more colors. Furthermore, the arrangement of the colored layer may be a known arrangement of a stripe, mosaic, triangle or four-pixel-arranged type, or any other type. The area of a region where the arrangement is formed is appropriately selected in accordance with the kind or the like of the color filter to be produced.

### 3. Photocatalyst-Containing Layer

Next, the photocatalyst-containing layer used in the invention is described. The photocatalyst-containing layer used in the invention is a layer containing a photocatalyst and a binder. The binder contained in the photocatalyst-containing layer is usually a binder decomposable or denaturable by the function of the photocatalyst accompanied with energy radiation so as to vary the characteristic of the photocatalyst-containing layer. The kind of the variation in the characteristic is not particularly limited. Thus, the binder may be, for example, a binder denaturable by the function of the photocatalyst accompanied with energy radiation so as to vary the adhesive property of the surface of the photocatalyst-containing layer. In the invention, the binder is in particular preferably a binder denaturable by the function of the photocatalyst accompanied with energy radiation so as to vary the wettability of the surface of the photocatalyst-containing layer. This makes it possible to form the colored layer by use of the pattern having the varied wettability in the photocatalyst-containing layer. The binder, the wettability of which is lowered in this way, the photocatalyst, and the method for varying the wettability of the photocatalyst-containing layer may be the same as described about the wettability-varied pattern forming step in the above-mentioned item “A. Method of producing a color filter”. Thus, the detailed description thereof is not repeated here.

### 4. Substrate

Next, the substrate used in the invention is described. The substrate is not particularly limited as long as the substrate is a substrate over which the photocatalyst-containing layer can be formed. The substrate may be the same as described about the item “A. Method of producing a color filter”. Thus, the detailed description thereof is not repeated here.

### 5. Color Filter

Next, the color filter of the invention is described. The color filter is not particularly limited as long as the filter is a color filter comprising the substrate, the photocatalyst-containing layer, the colored layer, and the light shielding part. If necessary, the color filter may have any other member, such as an alignment layer, or a transparent electrode layer.

Such members may be the same as used in ordinary color filters. Thus, the detailed description thereof is not repeated here.

The present invention is not limited to the embodiments. The embodiments are merely examples, and any one having the substantially same configuration as the technological idea disclosed in the claims of the present invention and the same effects is included in the technological scope of the present invention.

### EXAMPLES

The invention will be more specifically described by the following examples.

### Example 1

### Wettability-Varied Pattern Forming Step

### (Formation of a Photocatalyst-Containing Layer)

The following were mixed: 5 g of fluoroalkylsilane (TSL 8233 manufactured by GE Toshiba Silicones), 2 g of tetramethoxysilane, and 2 g of 1N hydrochloric acid. The resultant solution was then stirred for 8 hours, and 0.1 g of this solution was mixed with 5 g of a titanium oxide dispersion in water (ST-K01, manufactured by ISHIHARA SANGYO KAISHA, LTD.), which is a photocatalyst. The solution was coated onto a glass substrate with a spin coater, and dried at 150° C. for 10 minutes to form a substrate having a transparent photocatalyst-containing layer (thickness: 0.15 μm).

### (Formation of a Wettability-Varied Pattern)

A superhigh pressure mercury lamp was used to radiate energy (2000 mJ/cm² at 365 nm) onto the whole of a surface of the substrate having the photocatalyst-containing layer through a photomask having lines and spaces (openings parts: 80 μm, and a light shielding part: 20 μm). As a result, the wettability of only regions irradiated with the energy (a wettability-varied pattern) in the photocatalyst-containing layer was varied so that the contact angle with water turned into 10° or less.

### <Liquid Repellent Colored Layer Forming Step>

### (Formation of a Resin Colored Layer)

Next, a piezo-electrically driving type ink-jetting apparatus was used to cause the following to adhere onto the wettability-varied pattern: a UV curable polyfunctional acrylate monomer ink (resin colored layer forming coating solution) in each of colors R, G and B containing 5 parts by weight of a pigment, 20 parts by weight of a solvent, 5 parts by weight of a polymerization initiator and 70 parts by weight of a UV curable resin. Furthermore, the resultant was subjected to UV treatment to cure the resins. Thereafter, the resultant was subjected to heating treatment at 230° C. for 60 minutes to form resin colored layers. About each of the red, green and blue resin colored layer forming coating solutions; the solvent used therein was polyethylene glycol monomethylethyl acetate, the polymerization initiator used therein was IRGACURE 369 (trade name) manufactured by Ciba Speciality Chemicals, and the UV curable resin used therein was DPHA (dipentaerythritol hexaacrylate, manufactured by NIPPON KAYAKU CO., LTD.). The pigments used in the red, green and blue inks (the resin colored layer forming coating solutions) were C. I. Pigment Red 177, C. I. Pigment Green 36, and C. I. Pigment Blue 15+C. I. Pigment Violet 23, respectively.

### (Plasma Treatment)

Atmospheric pressure plasma was radiated onto the substrate wherein the resin colored layers were formed under the following conditions.

Introducing gas: CF₄ (flow rate: 151/min.)

Interval between electrodes and substrate: 2 mm

Power source output: 200 V-5 A

As a result, fluorine was introduced into only the resin colored layer, which exhibited liquid repellency (the measured value of the contact angle with a wettability index standard liquid having a surface tension of 30 mN/m was 54°), Its regions where the photocatalyst-containing layer was uncovered was lyophilic (the measured value of the contact angle with the wettability index standard liquid having the surface tension of 30 mN/m was 5°).

### <Light Shielding Part Forming Step>

A UV curable polyfunctional acrylate monomer ink for a light shielding part forming containing; 5 parts by weight of carbon black, 20 parts by weight of a solvent, 5 parts by weight of a polymerization initiator, and 70 parts by weight of a UV curable resin was used to form a light shielding part in spaces (20 μm) between the liquid repellent colored layers by an ink-jetting method.

### Example 2

### Liquid Repellent Colored Layer Forming Step

A UV curable polyfunctional acrylate monomer ink (liquid repellent colored layer forming composition) in each of colors R, G and B containing 5 parts by weight of a pigment, 18 parts by weight of a solvent, 5 parts by weight of a polymerization initiator, 70 parts by weight of a UV curable resin, and 2 parts by weight of a fluorine-containing surfactant (ZONYL FSN-100 manufactured by Du Pont Kabushiki Kaisha) was used, and layers obtained therefrom were patterned (into colored layer 80 μm in width and spaces 20 μm in width) by photolithography. In this way, liquid repellent colored layers were formed. About each of the red, green and blue inks; the solvent used therein was polyethylene glycol monomethylethyl acetate, the polymerization initiator used therein was IRGACURE 369 (trade name) manufactured by Ciba Speciality Chemicals, and the UV curable resin used therein was DPHA (dipentaerythritol hexaacrylate, manufactured by NIPPON KAYAKU CO., LTD.). The pigments used in the red, green and blue inks (the liquid repellent colored layer forming compositions) were C. I. Pigment Red 177, C. I. Pigment Green 36, and C. I. Pigment Blue 15+C. I. Pigment Violet 23, respectively.

As a result, the liquid repellent colored layer exhibited liquid repellency (the measured value of the contact angle with a wettability index standard liquid having a surface tension of 30 mN/m was 54°). Its regions where the glass substrate was uncovered was lyophilic (the measured value of the contact angle with the wettability index standard liquid having the surface tension of 30 mN/m was 5°).

### <Light Shielding Part Forming Step>

A UV curable polyfunctional acrylate monomer ink for a light shielding part forming containing 5 parts by weight of carbon black, 20 parts by weight of a solvent, 5 parts by weight of a polymerization initiator, and 70 parts by weight of a UV curable resin was used to form a light shielding part in spaces (20 μm) between the liquid repellent colored layers by an ink-jetting method as in the same manner as Example 1.

What is claimed is:

1. A color filter comprising; a substrate, a photocatalyst-containing layer which is formed on the substrate and contains at least a photocatalyst and a binder, a colored layer formed in a pattern form on the photocatalyst-containing layer, and a light shielding part formed to cover an opening part partitioned by the colored layer and a plurality of edges of the colored layer.
